(19) United States
(12) Patent Application Publication
(10) Pub. No.: US 2010/0162683 A1
(43) Pub. Date: Jul. 1, 2010

(54) TURBOFAN ENGINE

(76) Inventors: Zbigniew M. Grabowski, Farmington, CT (US); William J. McVey, North Granby, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/377,623

(22) PCT Filed: Oct. 12, 2006
(86) PCT No.: PCT/US06/39942

§ 371 Date: Feb. 16, 2009

(51) Int. Cl. F02K 3/06; F02K 1/06; F02C 7/36

(52) U.S. Cl. 60/226.3

(57) ABSTRACT

A turbofan engine is provided that includes a fan nacelle surrounding a core nacelle. The core nacelle houses a spool. The fan and core nacelles provide a bypass flow path having a nozzle exit area. A turbofan is arranged within the fan nacelle upstream from the core nacelle. A flow control device is adapted to effectively change the nozzle exit area to obtain a desired operating condition for the turbofan engine. A gear train couples the spool and turbofan for reducing a turbofan rotational speed relative to a spool rotational speed. A controller is programmed to respond to at least one sensor. The controller is programmed to effectively control the nozzle area.

### BACKGROUND OF THE INVENTION

This invention relates to a turbofan engine, and more particularly, the invention relates to a turbofan engine having an effectively variable nozzle exit area.

A turbofan engine typically includes a fan nacelle surrounding a core nacelle. A spool is housed in the core nacelle and supports a compressor and turbine. A turbofan is arranged in the fan nacelle upstream from the core nacelle. Flow from the turbofan bypasses the core nacelle through a bypass flow path arranged between the core and fan nacelles. The bypass flow path includes an exit nozzle that is typically fixed. In many turbofan engines, the turbofan is driven directly by the spool and rotates at the same speed as the spool.

The engine's design is affected by such factors as the pressure ratio of the turbofan. Propulsive efficiency improvements, and hence fuel consumption, can be gained by reducing the turbofan pressure ratio. Direct drive turbofan engines have several design challenges. In one example, the speed of the spool is determined by the appropriate tip speed for a desired turbofan pressure ratio. In some applications, as the turbofan pressure ratio is reduced, additional compressor and turbine stages must be added to the spool to obtain the needed amount of work from the compressor and turbine at this speed. The result is increased engine weight and cost.

Some turbofan engines employ structure at the aft portion of the bypass flow path that is used to change the physical area of the nozzle. This arrangement enables manipulation of various engine operating conditions by increasing and decreasing the nozzle area. However, this type of engine arrangement has used a turbofan driven directly by the spool.

What is needed is a turbofan engine having a turbofan that is decoupled from the low spool and provisioned with an effectively adjustable fan nozzle that provides improved efficiency.

### SUMMARY OF THE INVENTION

A turbofan engine is provided that includes a fan nacelle surrounding a core nacelle. The core nacelle houses a spool. The fan and core nacelles provide a bypass flow path having a nozzle exit area. A turbofan is arranged within the fan nacelle upstream from the core nacelle. A flow control device is adapted to effectively change the nozzle exit area to obtain a desired operating condition for the turbofan engine. A gear train couples the spool and turbofan for reducing a turbofan rotational speed relative to the spool rotational speed.

These and other features of the present invention can be best understood from the following specification and drawings, where the following is a brief description of the invention.

### BRIEF DESCRIPTION OF THE DRAWINGS

FIG. 1 is a cross-sectional view of an example turbofan engine.

FIG. 2 is a partially broken perspective view of the turbofan engine shown in FIG. 1.

FIG. 3 is a schematic of a gear train shown in FIG. 1.

### DETAILED DESCRIPTION OF THE PREFERRED EMBODIMENT

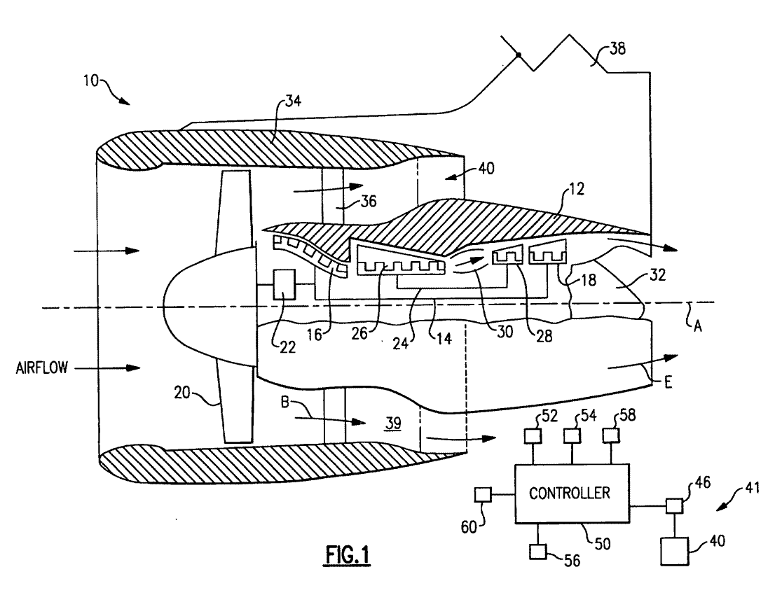

A geared turbofan engine 10 is shown in FIG. 1. A pylon 38 secures the engine 10 to an aircraft. The engine 10 includes a core nacelle 12 that houses a low spool 14 and high spool 24 rotatable about an axis A. The low spool 14 supports a low pressure compressor 16 and low pressure turbine 18. In the example, the low spool 14 drives a turbofan 20 through a gear train 22. The high spool 24 supports a high pressure compressor 26 and high pressure turbine 28. A combustor 30 is arranged between the high pressure compressor 26 and high pressure turbine 28. Compressed air from compressors 16, 26 mixes with fuel from the combustor 30 and is expanded in turbines 18, 28.

Airflow enters a fan nacelle 34, which surrounds the core nacelle 12 and turbofan 20. The turbofan 20 directs air into the core nacelle 12, which is used to drive the turbines 18, 28, as is known in the art. Turbine exhaust E exits the core nacelle 12 once it has been expanded in the turbines 18, 28, in a passage provided between the core nacelle and a tail cone 32.

The core nacelle 12 is supported within the fan nacelle 34 by structure 36, which are commonly referred to as upper and lower bifurcations. A generally annular bypass flow path 39 is arranged between the core and fan nacelles 12, 34. The example illustrated in FIG. 1 depicts a high bypass flow arrangement in which approximately eighty percent of the airflow entering the fan nacelle 34 bypasses the core nacelle 12. The bypass flow B within the bypass flow path 39 exits the fan nacelle 34 through a nozzle exit area 40.

For the engine 10 shown in FIG. 1, a significant amount of thrust may be provided by the bypass flow B due to the high bypass ratio. Thrust is a function of density, velocity and area. One or more of these parameters can be manipulated to vary the amount and direction of thrust provided by the bypass flow B. In one example, the engine 10 includes a structure associated with the nozzle exit area 40 to change the physical area and geometry to manipulate the thrust provided by the bypass flow B. However, it should be understood that the nozzle exit area might be effectively altered by other than structural changes, for example, by altering the boundary layer, which changes the flow velocity. Furthermore, it should be understood that any device used to effectively change the nozzle exit area is not limited to physical locations near the exit of the fan nacelle 34, but rather, includes altering the bypass flow B at any suitable location in the bypass flow path.

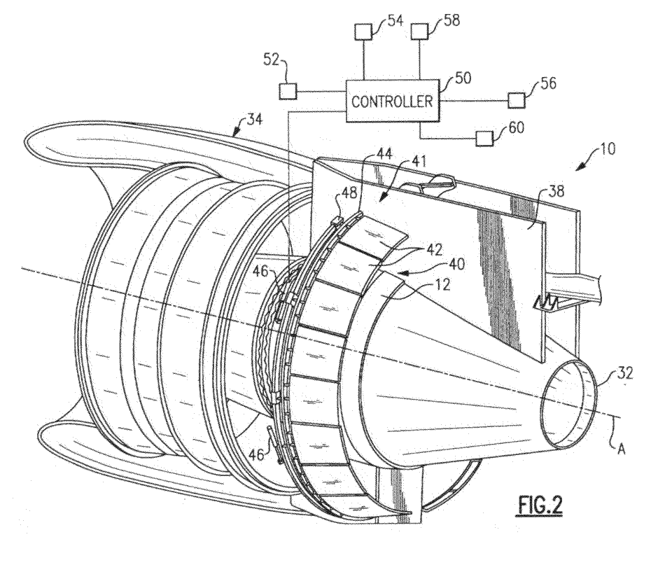

The engine 10 has a flow control device 41, indicated in FIG. 2 that is used to effectively change the nozzle exit area. In one example, the flow control device 41 provides the fan nozzle exit area 40 for discharging axially the bypass flow B pressurized by the upstream turbofan 20 of the engine 10. A significant amount of thrust is provided by the bypass flow B due to the high bypass ratio. The turbofan 20 of the engine 10 is designed for a particular flight condition, typically cruise at 0.8 Mach and 35,000 feet. The turbofan 20 is designed at a particular fixed stagger angle for an efficient cruise condition. The flow control device 41 is operated to vary the nozzle exit area 40 to adjust fan bypass airflow such that the angle of attack or incidence on the fan blade is maintained close to design incidence at other flight conditions, such as landing and takeoff. This enables desired engine operation over a range of flight conditions with respect to engine performance and other engine operational parameters such as noise level. In one example, the flow control device 41 defines a nominal converged position for the nozzle exit area 40 at cruise and climb conditions, and radially opens relative thereto to define a diverged nozzle position for other flight conditions. The flow control device 41 provides an approximately 20% change in the nozzle exit area 40.

In one example, the flow control device 41 includes multiple hinged flaps 42 arranged circumferentially about the rear of the fan nacelle 34. The hinged flaps 42 can be actuated independently and/or in groups using segments 44. In one example, the segments 44 and each hinged flap 42 can be moved angularly using actuators 46. The segments 44 are guided by tracks 48 in one example.

A controller 50 is programmed to command the flow control device 41 to effectively change the nozzle exit area 40 for achieving a desired engine operating condition. In one example, sensors 52-60 communicate with the controller 50 to provide information indicative of an undesired engine operating condition. In the example shown in FIG. 2, the controller 50 commands actuators 46 to move the flaps to physically increase or decrease the size of the nozzle exit area 40.

In the examples shown, the engine 10 is a high bypass turbofan arrangement. In one example, the bypass ratio is greater than 10:1, and the turbofan diameter is substantially larger than the diameter of the low pressure compressor 16. The low pressure turbine 18 has a pressure ratio that is greater than 5:1, in one example.

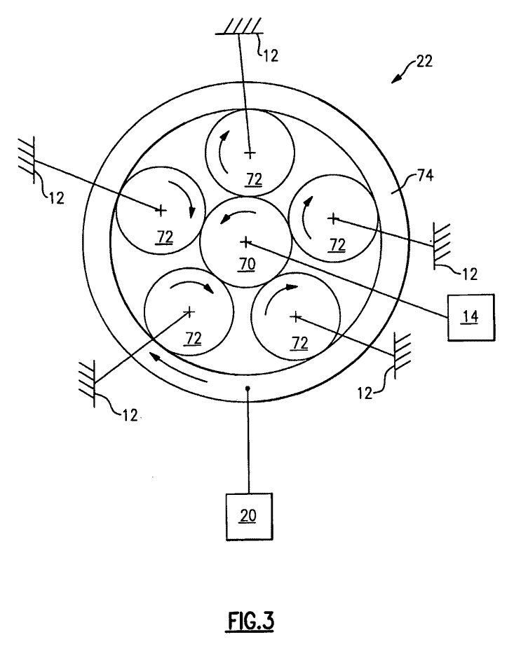

The gear train 22 is an epicyclical gear train, for example, which is shown in FIG. 3. In one example, the epicyclical gear train is a star gear train, providing a gear reduction ratio of greater than 2.5:1. The gear train 22 includes a sun gear 70 that is coupled to the low spool 14. Star gears 72 surround and mesh with the sun gear 70. The star gears 72 are fixed against rotation about the sun gear 70 by rotationally supporting the star gear 72 with structure grounded to the core nacelle 12. A ring gear 74 surrounds and meshes with the star gears 72. The turbofan 20 is driven by and connected to the ring gear 76. Thus, gear train 22 rotationally drives the turbofan 20 at a slower speed relative to low spool 14. As a result, a lower pressure ratio across the turbofan 20 can be attained, which provides greater fuel efficiency. Further, the slower speed of the turbofan 20 as compared to the low spool 14 requires less structural reinforcement than direct drive turbofan engines due to the lower fan blade tip speed. Moreover, additional compressor and turbine stages can be eliminated since the low spool 14 can rotate faster than the turbofan 20.

It should be understood, however, that the above parameters are only exemplary of a contemplated geared turbofan engine. Although an example embodiment of this invention has been disclosed, a worker of ordinary skill in this art would recognize that certain modifications would come within the scope of this invention. For that reason, the following claims should be studied to determine the true scope and content of this invention.

1.-18. (canceled)

19. A turbofan engine comprising:
a fan nacelle surrounding a core nacelle that houses a spool, wherein the spool is a low spool, the core nacelle houses a high spool rotatable relative to the low spool, and a low pressure compressor and turbine are mounted on the low spool, the fan and core nacelles providing a bypass flow path having a nozzle exit area;
a turbofan arranged within the fan nacelle upstream from the core nacelle;
a flow control device adapted to effectively change the nozzle exit area to obtain a desired operating condition for the turbofan engine; and
a gear train coupling the spool and turbofan for reducing a turbofan rotational speed relative to a spool rotational speed.

20. The turbofan engine according to claim 19, wherein the flow control device includes a controller programmed to effectively change the nozzle exit area in response to a condition detected by at least one sensor indicative of an undesired operating condition to obtain the desired operating condition.

21. The turbofan engine according to claim 20, wherein the controller commands an actuator to physically change a size of the nozzle exit area.

22. The turbofan engine according to claim 19, wherein the gear train is an epicyclical gear train.

23. The turbofan engine according to claim 22, wherein the epicyclical gear train is a star gear train.

24. The turbofan engine according to claim 19, wherein a high pressure compressor and turbine are mounted on the high spool.

25. A turbofan engine comprising:
a fan nacelle surrounding a core nacelle that houses a spool, wherein the spool is a low spool, the core nacelle houses a high spool rotatable relative to the low spool, and a low pressure compressor and turbine are mounted on the low spool, the fan and core nacelles providing a bypass flow path having a nozzle exit area;
a turbofan arranged within the fan nacelle upstream from the core nacelle;
a flow control device adapted to effectively change the nozzle exit area to obtain a desired operating condition for the turbofan engine; and
an epicyclical gear train coupling the spool and turbofan for reducing a turbofan rotational speed relative to a spool rotational speed.

26. The turbofan engine according to claim 25, wherein the flow control device includes a controller programmed to effectively change the nozzle exit area in response to a condition detected by at least one sensor indicative of an undesired operating condition to obtain the desired operating condition.

27. The turbofan engine according to claim 26, wherein the controller commands an actuator to physically change a size of the nozzle exit area.

28. The turbofan engine according to claim 25, wherein the epicyclical gear train is a star gear train.

29. The turbofan engine according to claim 28, wherein the star gear train provides a gear reduction ratio of greater than 2.5:1.

30. The turbofan engine according to claim 25, wherein the epicyclic gear train provides a gear reduction ratio of greater than 2.5:1.

31. The turbofan engine according to claim 30, wherein the bypass flow path provides a bypass ratio greater than 10:1.
